(19) United States
(12) Patent Application Publication
(10) Pub. No.: US 2023/0255849 A1
(43) Pub. Date: Aug. 17, 2023

(54) POSE-ADJUSTABLE RIGID-FLEXIBLE COUPLED WAIST REHABILITATION ROBOT

(71) Applicant: Yanshan University, Qinhuangdao City (CN)

(72) Inventors: Jianye NIU, Qinhuangdao City (CN); Junjie TIAN, Qinhuangdao City (CN); Siyuan ZHENG, Qinhuangdao City (CN); Lipeng WANG, Qinhuangdao City (CN); Xingchao ZHANG, Qinhuangdao City (CN); Shanshan LI, Qinhuangdao City (CN); Zhiwen JIANG, Qinhuangdao City (CN)

(21) Appl. No.: 18/097,830

(22) Filed: Jan. 17, 2023

(30) Foreign Application Priority Data
Feb. 15, 2022 (CN) 202210138452.0

(51) Int. Cl. A61H 1/02

(52) U.S. Cl. CPC A61H 1/0292; A61H 2201/1659; A61H 2201/1623; A61H 2201/1654; A61H 2201/0103; A61H 2201/14; A61H 2201/5058; A61H 2201/0169; A61H 2201/0192; A61H 2201/165

(57) ABSTRACT

The present disclosure belongs to the technical field of rehabilitation medical devices, and in particular relates to a pose-adjustable rigid-flexible coupled waist rehabilitation robot. The robot comprises a fixed platform, a movable platform connected to the fixed platform, a lumbar vertebra support assembly mounted on the movable platform, and two support airbags symmetrically arranged at both sides of the lumbar vertebra support assembly. The lumbar vertebra support assembly comprises a plurality of bellow air bags arranged in parallel. By controlling the pressure in a plurality of bellow air bags arranged in parallel, the lumbar vertebra support assembly at the lumbar vertebra position can be adjusted to different curvatures to adapt to different patients, such that the lumbar vertebra support assembly can support the lumbar vertebra part of the patient in a perfectly fitting manner to guarantee the comfort in the rehabilitation training process.

### CROSS REFERENCE TO RELATED APPLICATION

This patent application claims the benefit and priority of Chinese Patent Application No. 202210138452.0, filed on Feb. 15, 2022, the disclosure of which is incorporated by reference herein in its entirety as part of the present application.

### TECHNICAL FIELD

The present disclosure belongs to the technical field of rehabilitation medical devices, and in particular relates to a pose-adjustable rigid-flexible coupled waist rehabilitation robot.

### BACKGROUND ART

Lumbar vertebra disc herniation, postpartum protection, lumbar vertebra muscle strain and lumbar vertebra spondylosis are common orthopedic diseases nowadays. Rehabilitation device is a conventional method for lumbar vertebra rehabilitation. Reasonable and reliable traction can relieve the pain of the waist, help to reduce or eliminate the compression of lumbar vertebra vertebrae on vertebral artery, promote blood circulation, improve and coordinate the internal and external balance of the damaged lumbar vertebra vertebrae, and gradually restore the lumbar vertebra vertebrae to a healthy state. For patients with severe lumbar vertebra injuries, the rehabilitation device can drive the waist to pitch back and forth, sway left and right, and move up and down to make the patients recover slowly. However, due to the complexity of the back of the human body, the lumbar vertebra part is relatively concave, and the surface of the conventional hard rehabilitation device is difficult to perfectly fit with the back of the human body. Moreover, rigid rehabilitation device is easy to make patients have conflict psychology and unwilling to cooperate with treatment for a long time due to its poor comfort.

### SUMMARY

To overcome the defects in the prior art that the rehabilitation device is difficult to perfectly fit with the back of the human body and has poor comfort, an objective of the present disclosure is to provide a safe, comfortable and pose-adjustable rigid-flexible coupled waist rehabilitation robot.

The technical solution employed by the present disclosure to solve the technical problem is as follows:

A pose-adjustable rigid-flexible coupled waist rehabilitation robot, comprising a fixed platform, a movable platform connected to the fixed platform, a lumbar vertebra support assembly mounted on the movable platform, and two support airbags symmetrically arranged at both sides of the lumbar vertebra support assembly; and the lumbar vertebra support assembly comprises a plurality of bellow air bags arranged in parallel.

Further, the lumbar vertebra support assembly further comprises: a mounting frame fixed to each bellow air bag and a reflection grating between the mounting frame and the movable platform.

Further, the movable platform is driven by a 3-PRS parallel mechanism arranged on the fixed platform, and each branch mechanism of the 3-PRS parallel mechanism comprises a ball screw drive pair, a connecting plate connected to the output end of the ball screw drive pair, a rotating shaft bracket arranged on the connecting plate, a revolute joint rotationally connected to the rotating shaft bracket, and a spherical joint connected to the revolute joint; and the spherical joint is fixedly connected to the movable platform.

Further, the revolute joint is that a U-shaped frame rotationally connected to the rotating shaft bracket; the spherical joint is that an end part of a cylinder is provided with a universal sphere, the cylinder is fixedly connected to the U-shaped frame, the universal sphere is provided with a threaded hole, the universal sphere is fixed connected to the movable platform by a bolt.

Further, a bearing pulley is rotationally connected to the rotating shaft bracket, and the bearing pulley rolls on the upper surface of the fixed platform.

Further, the connecting plate is provided with an upright post; the fixed platform is provided with a track parallel to a linear motion direction of the ball screw drive pair; and the upright post is slidably connected in the track.

Further, the spherical joints of the three branch mechanisms form an isosceles triangle on the plane.

Further, the end part of the track is provided with a displacement sensor for detecting the displacement of the upright post.

Further, a gasket is provided between each of four corners of each support airbag and the movable platform, and the support airbag is connected to the movable platform by bolts penetrating through four bolt holes and the gaskets.

Furthermore, the support airbag and the bellow air bag are externally provided with a soft silica gel layer.

The pose-adjustable rigid-flexible coupled waist rehabilitation robot disclosed by the present disclosure has the beneficial effects that:

1. By controlling the pressure in a plurality of bellow air bags arranged in parallel, the lumbar vertebra support assembly at the lumbar vertebra position can be adjusted to different curvatures to adapt to different patients, such that the lumbar vertebra support assembly can support the lumbar vertebra part of the patient in a perfectly fitting manner to guarantee the comfort in the rehabilitation training process.

2. The drive of a 3-PRS parallel mechanism can enable the movable platform to drive the back of the human body to move up and down, pitch back and forth, and sway from side to side. By providing gaskets between the support airbag and the movable platform, there is a certain gap between the support airbag and the movable platform to accommodate the inflated support airbag conveniently; and on the other hand, the abnormal noise caused by the contact between the four corners of the support airbag and the movable platform is reduced.

3. The back of the human body is in contact with the soft silica gel to further improve the comfort of the patient during rehabilitation training.

### BRIEF DESCRIPTION OF THE DRAWINGS

The following further describes the present disclosure in detail with reference to the accompanying drawings and specific embodiments.

FIG. 1 is an overall external view in accordance with an embodiment of the present disclosure;

FIG. 2 is an exploded view in accordance with an embodiment of the present disclosure;

FIG. 3 is an internal structure diagram in accordance with an embodiment of the present disclosure;

FIG. 4 is a diagram of a 3-PRS parallel mechanism in accordance with an embodiment of the present disclosure;

FIG. 5 is a three-dimensional diagram of a branch mechanism in accordance with an embodiment of the present disclosure;

FIG. 6 is a diagram of a partial structure of a branch mechanism in accordance with an embodiment of the present disclosure;

FIG. 7 is a structure diagram on a movable platform in accordance with an embodiment of the present disclosure;

FIG. 8 is a structure diagram of a lumbar vertebra support assembly in accordance with an embodiment of the present disclosure.

In the drawings: 1—fixed platform; 2—movable platform; 3—lumbar vertebra support assembly; 30—bellow air bag; 31—mounting frame; 32—reflection grating; 4—support airbag; 5—ball screw drive pair; 6—connecting plate; 7—rotating shaft bracket; 8—U-shaped frame; 9—cylinder; 10—universal sphere; 11—bearing pulley; 12—upright post; 13—track; 14—displacement sensor; 15—gasket; 16—soft silica gel layer; 17—housing; 19—first branch mechanism; 20—second branch mechanism; 21—third branch mechanism.

### DETAILED DESCRIPTION OF THE EMBODIMENTS

Now, the present disclosure is further described in detail with reference to the accompanying drawings. Such accompanying drawings are all simplified schematic diagrams to illustrate the basic structure of the present disclosure only in a schematic way, so they only show the components related to the present disclosure.

A specific embodiment of a pose-adjustable rigid-flexible coupled waist rehabilitation robot of the present disclosure shown in FIG. 1 to FIG. 8 comprises a fixed platform 1, a movable platform 2 connected to the fixed platform 1, a lumbar vertebra support assembly 3 mounted on the movable platform 2, and two support airbags 4 symmetrically arranged at both sides of the lumbar vertebra support assembly 3. The fixed platform 1 is externally provided with a housing, and the upper surface of the housing is provided with a soft silica gel layer 16.

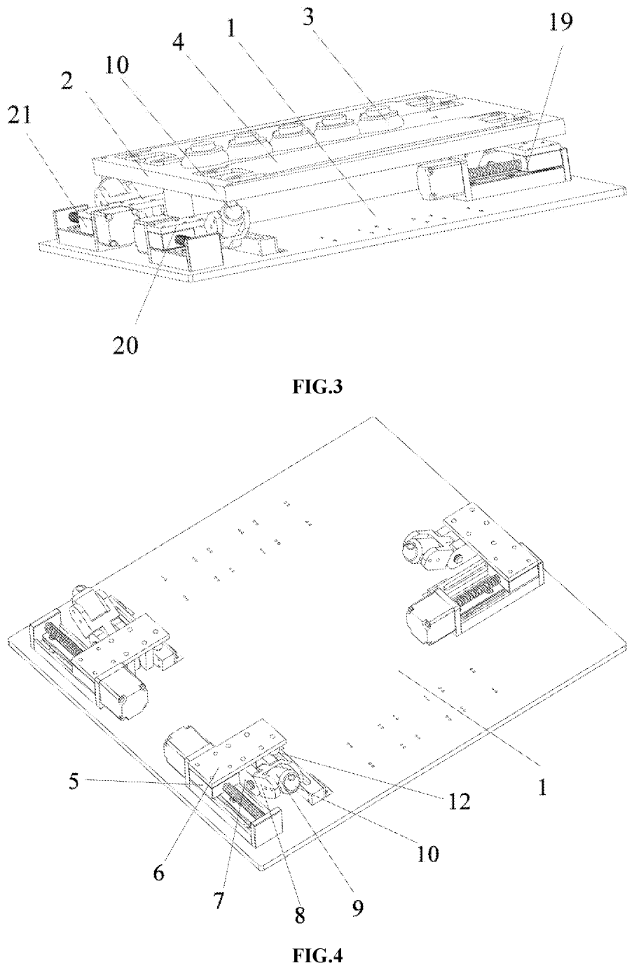

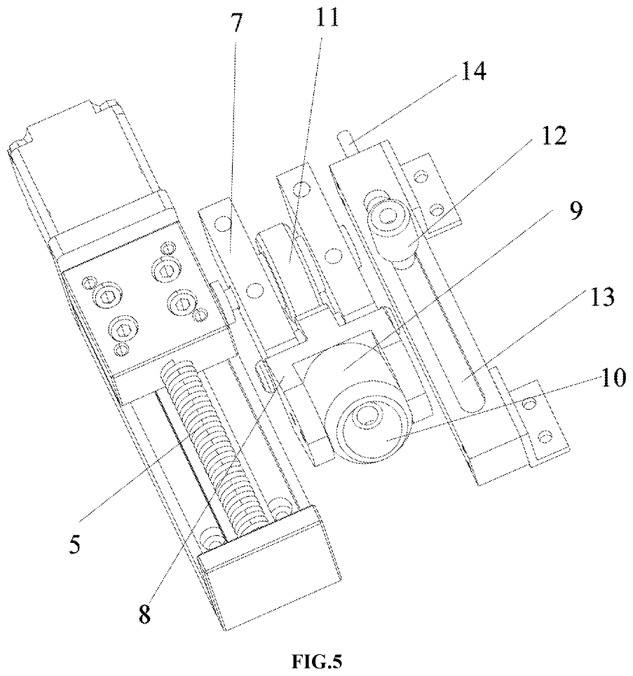

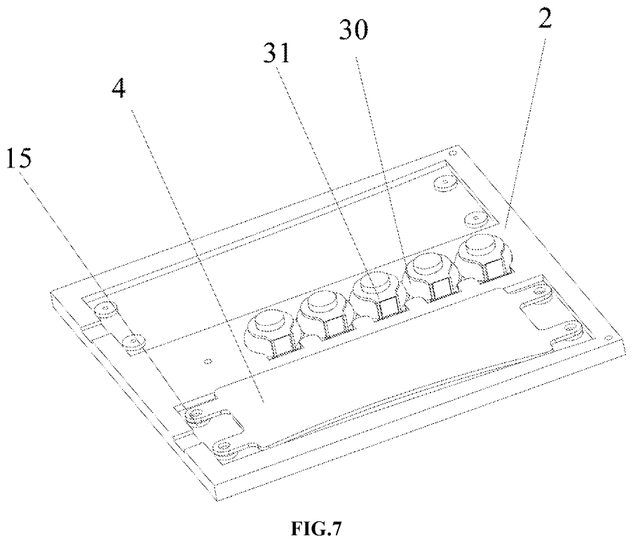

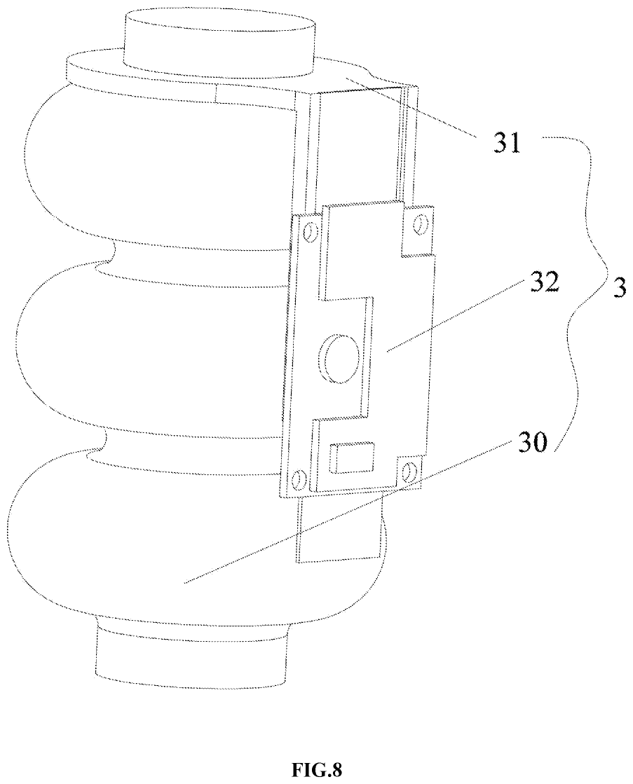

In conjunction with FIG. 3, FIG. 7 and FIG. 8, the lumbar vertebra support assembly comprises a plurality of bellow air bags 30 arranged in parallel, mounting frames 31 fixed onto the bellow air bags 30, and reflection gratings 32 installed between the mounting frames 31 and the movable platform 2. In accordance with the present disclosure, there are five longitudinally arranged bellow air bags 30, and the reflection grating 32 is slidably connected to each mounting frame 31 up and down and is used to measure the displacement of the bellow air bag 30 caused by the change of inflated pressure, that is, to measure the extension degree of each bellow air bag 30. By controlling the amount of air pressure in the five bellow air bags 30, the curvatures of the entire row of bellow air bags 30 may be adjusted to fit the lumbar vertebra of different patients, thus providing a perfectly fitting support for the lumbar vertebra.

The support airbags 4 at both sides of the bellow air bags 30 may support the back at both sides of the lumbar vertebra of the human body better. A gasket 15 is provided between each of four corners of each support airbag 4 and the movable platform 2, the support airbag 4 is connected to the movable platform 2 by bolts penetrating through four bolt holes and the gaskets 15. By providing the gaskets 15 between each support airbag 4 and the movable platform 2, there is a certain gap between the support airbag 4 and the movable platform 2 to accommodate the inflated support airbag 4 conveniently; and on the other hand, the abnormal noise caused by the contact between the four corners of the support airbag 4 and the moving platform 2 can be reduced.

To guarantee the comfort of the patient during training, the support airbag 4 and the bellow air bag 30 are externally provided with the soft silica gel layer 16, and the soft silica gel layer 16 is connected to the notch in the upper part of the housing 17.

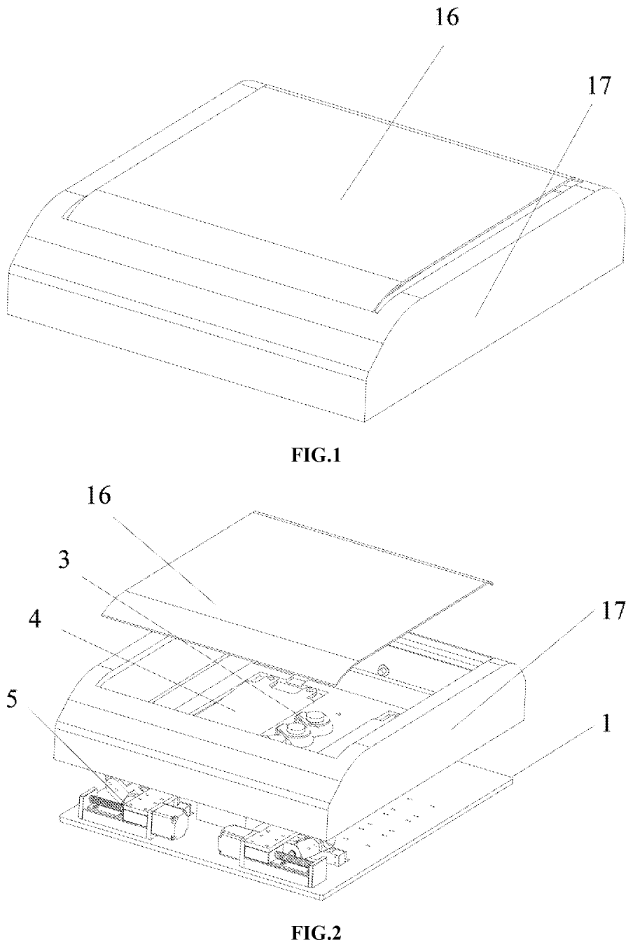

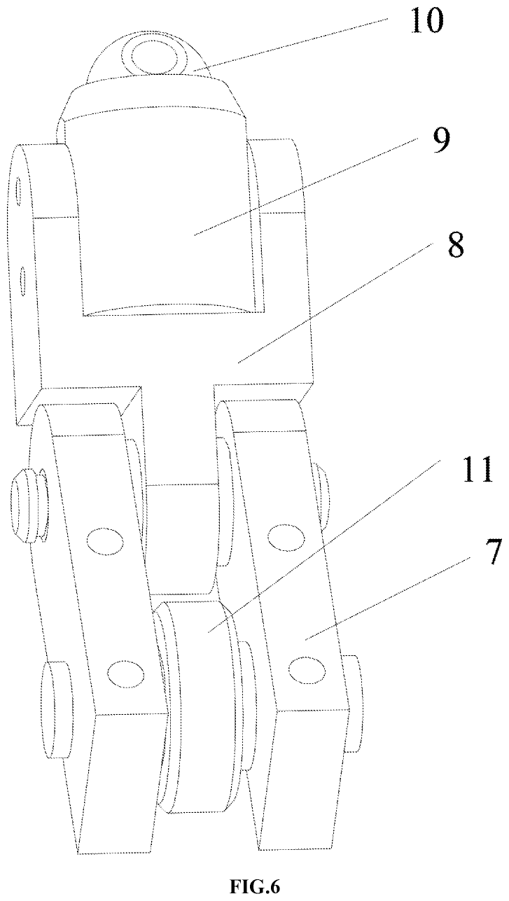

Referring to FIG. 2, FIG. 3, FIG. 5 and FIG. 6, the movable platform 2 is driven by a 3-PRS parallel mechanism arranged on the fixed platform 1, each branch mechanism of the 3-PRS parallel mechanism comprises a ball screw drive pair 5, a connecting plate 6 connected to the output end of the ball screw drive pair 5, a rotating shaft bracket 7 arranged on the connecting plate 6, a revolute joint rotationally connected to the rotating shaft bracket 7, and a spherical joint connected to the revolute joint. The spherical joint is fixedly connected to the movable platform 2. The revolute joint is that a U-shaped frame 8 rotationally connected to the rotating shaft bracket 7. The spherical joint is that an end part of a cylinder 9 is provided with a universal sphere 10, the cylinder 9 is fixedly connected to the U-shaped frame 8, the universal sphere 10 is provided with a threaded hole, and the universal sphere 10 is fixed connected to the movable platform 2 by a bolt. A bearing pulley 11 is rotationally connected to the rotating shaft bracket 7, and the bearing pulley 11 rolls on the upper surface of the fixed platform 1. The connecting plate 6 is provided with an upright post 12. The fixed platform 1 is provided with a track 13 parallel to a linear motion direction of the ball screw drive pair; the upright post 12 is slidingly connected into the track 13. The end part of the track 13 is provided with a displacement sensor 14 for detecting the displacement of the upright post 12.

In accordance with this embodiment, the spherical joints of the three branch mechanisms form an isosceles triangle on a plane, where the center of the spherical joint of the first branch mechanism 19 is located at a middle position of the two support airbags 4; the second branch mechanism 20 and the third branch mechanism 21 are symmetrically arranged at the lower sides of the support airbags 4 respectively, and the spherical joints of the second branch mechanism 20 and the third branch mechanism 21 are oriented towards the left side and the right side of the fixed platform 1, and the spherical joint of the first branch mechanism 19 is oriented towards the front side of the fixed platform 1.

The operating principle of the present disclosure is as follows: the movable platform 2 may move up and down stably through the simultaneous motion of three ball screw drive pairs 5, the waist of the human body may be driven to sway from side to side through the coordinated motion of the second branch mechanism 20 and the third branch mechanism 21; and the pitching motion of the waist part of the human body may be achieved through the synchronous lifting of the second branch mechanism 20 and the third branch mechanism 21 and the reverse lifting motion of the first branch mechanism 19.

It should be understood that the above specific embodiments are only used to explain the present disclosure rather than limiting the present disclosure. Obvious variations or changes derived from the spirit of the present disclosure is still within the scope of protection of the present disclosure.

What is claimed is:

1. A pose-adjustable rigid-flexible coupled waist rehabilitation robot, comprising a fixed platform (1), a movable platform (2) connected to the fixed platform (1), a lumbar vertebra support assembly (3) mounted on the movable platform (2), and two support airbags symmetrically arranged at both sides of the lumbar vertebra support assembly (3); and the lumbar vertebra support assembly (3) comprises a plurality of bellow air bags (30) arranged in parallel.

2. The pose-adjustable rigid-flexible coupled waist rehabilitation robot according to claim 1, wherein the lumbar vertebra support assembly (3) further comprises: a mounting frame (31) fixed to each bellow air bag (30) and a reflection grating between the mounting frame (31) and the movable platform (2).

3. The pose-adjustable rigid-flexible coupled waist rehabilitation robot according to claim 1, wherein the movable platform (2) is driven by a 3-PRS parallel mechanism arranged on the fixed platform (1), and each branch mechanism of the 3-PRS parallel mechanism comprises a ball screw drive pair (5), a connecting plate (6) connected to the output end of the ball screw drive pair (5), a rotating shaft bracket (7) arranged on the connecting plate (6), a revolute joint rotationally connected to the rotating shaft bracket (7), and a spherical joint connected to the revolute joint; and the spherical joint is fixedly connected to the movable platform (2).

4. The pose-adjustable rigid-flexible coupled waist rehabilitation robot according to claim 3, wherein the revolute joint is that a U-shaped frame (8) rotationally connected to the rotating shaft bracket (7); the spherical joint is that an end part of a cylinder (9) is provided with a universal sphere (10), the cylinder (9) is fixedly connected to the U-shaped frame (8), the universal sphere (10) is provided with a threaded hole, the universal sphere (10) is fixed connected to the movable platform (2) by a bolt.

5. The pose-adjustable rigid-flexible coupled waist rehabilitation robot according to claim 4, wherein a bearing pulley (11) is rotationally connected to the rotating shaft bracket (7), and the bearing pulley (11) rolls on the upper surface of the fixed platform (1).

6. The pose-adjustable rigid-flexible coupled waist rehabilitation robot according to any one of claim 3, wherein the connecting plate (6) is provided with an upright post (12); the fixed platform (1) is provided with a track (13) parallel to a linear motion direction of the ball screw drive pair; and the upright post (12) is slidably connected in the track (13).

7. The pose-adjustable rigid-flexible coupled waist rehabilitation robot according to any one of claim 4, wherein the connecting plate (6) is provided with an upright post (12); the fixed platform (1) is provided with a track (13) parallel to a linear motion direction of the ball screw drive pair; and the upright post (12) is slidably connected in the track (13).

8. The pose-adjustable rigid-flexible coupled waist rehabilitation robot according to any one of claim 5, wherein the connecting plate (6) is provided with an upright post (12); the fixed platform (1) is provided with a track (13) parallel to a linear motion direction of the ball screw drive pair; and the upright post (12) is slidably connected in the track (13).

9. The pose-adjustable rigid-flexible coupled waist rehabilitation robot according to claim 1, wherein the spherical joints of the three branch mechanisms form an isosceles triangle on the plane.

10. The pose-adjustable rigid-flexible coupled waist rehabilitation robot according to claim 6, wherein the end part of the track (13) is provided with a displacement sensor (14) for detecting the displacement of the upright post (12).

11. The pose-adjustable rigid-flexible coupled waist rehabilitation robot according to claim 7, wherein the end part of the track (13) is provided with a displacement sensor (14) for detecting the displacement of the upright post (12).

12. The pose-adjustable rigid-flexible coupled waist rehabilitation robot according to claim 8, wherein the end part of the track (13) is provided with a displacement sensor (14) for detecting the displacement of the upright post (12).

13. The pose-adjustable rigid-flexible coupled waist rehabilitation robot according to claim 1, wherein a gasket (15) is provided between each of four corners of each support airbag (4) and the movable platform (2), and the support airbag (4) is connected to the movable platform (2) by bolts penetrating through four bolt holes and the gaskets (15).

14. The pose-adjustable rigid-flexible coupled waist rehabilitation robot according to claim 1, wherein the support airbag (4) and the bellow air bag are externally provided with a soft silica gel layer (16).
